(19) United States
(12) Patent Application Publication
(10) Pub. No.: US 2010/0171750 A1
(43) Pub. Date: Jul. 8, 2010

(54) METHOD AND DEVICE FOR GENERATING A COMPLEXITY VECTOR FOR AT LEAT ONE PART OF AN SVG SCENE, AND METHOD AND TESTING DEVICE FOR TESTING A PLAYBACK SUITABILITY OF AT LEAST PART OF AN SVG SCENE ON DEVICE

(76) Inventors: Michael Eberhard, Maria Saal (AT); Thomas Riegel, Hohenbrunn (DE)

Correspondence Address: STAAS & HALSEY LLP, SUITE 700, 1201 NEW YORK AVENUE, N.W., WASHINGTON, DC, 20005, US

(21) Appl. No.: 12/452,652

(22) PCT Filed: Jun. 6, 2008
(86) PCT No.: PCT/EP2008/057064

§ 371 Date: Jan. 13, 2010

(30) Foreign Application Priority Data
Jul. 13, 2007 (DE) 10 2007 032 812.7

(51) Int. Cl. G09G 5/02; G06T 11/20

(52) U.S. Cl. 345/589; 345/443

(57) ABSTRACT

A complexity vector representing a complexity of at least part of an SVG scene is generated based on a complexity variable associated with at least one element of a DOM tree of the SVG scene. The playback suitability of at least part of an SVG scene is tested for a device based on whether a complexity variable of a complexity vector of the SVG scene is smaller than or equal to the associated device complexity variable of a device complexity vector of the device per element, wherein a maximum complexity of the element of a DOM tree of the SVG scene is played back on the device via the complexity variable, and a maximum executable complexity of the element is played back on the device via the device complexity variable.

### CROSS REFERENCE TO RELATED APPLICATIONS

This application is the U.S. national stage of International Application No. PCT/EP2008/057064, filed Jun. 6, 2008 and claims the benefit thereof. The International Application claims the benefits of German Application No. 102007032812.7 filed on Jul. 13, 2007, both applications are incorporated by reference herein in their entirety.

### BACKGROUND

Described below are a method and a device for generating a complexity vector for at least one part of an SVG scene, and a method and a testing device for testing a playback suitability of at least one part of an SVG scene on a device.

The SVG standard (SVG—Scalable Vector Graphics) is a standard for the description of two-dimensional vector graphics in the XML syntax (XML—Extensible Markup Language). SVG supports three fundamentally different types of elements:
vector graphics, constructed from graphical primitives;
raster graphics, in other words normal bitmap images which can be linked in externally;
text in preselectable fonts.

In this situation, the SVG scene describes one or more objects. Furthermore, the SVG scene can also have interactions or links to external information. An SVG document describes the SVG scene and in doing so comprises one or more of the aforementioned types. Further details on the SVG standard can be found for example in SVG—Scalable Vector Graphics, 1.1 Specification, W3C Recommendation, 14 Jan. 2003, which is available at www.w3.org/TR/2003/REC-SVG11-20030114/REC-SVG11-20030114.pdf. Thanks to the scalability of SVG, vector graphics can be tailored to the particular circumstances of a device, a PDA for example (PDA—Personal Digital Assistant) or a mobile radio device, whereby the vector graphics are rendered. Raster graphics on the other hand have a fixed resolution and need to be interpolated in the case of greater variations, which is also accompanied by a greater computing requirement in addition to a loss in quality. Specifically to satisfy the needs of lower power terminal devices, such as a mobile telephone for example, SVG has been restricted to a subset, the so-called SVGT (SVGT—SVG Tiny), a first profile of the mobile SVG standard, see Mobile SVG Profiles: SVG Tiny and SVG Basic, W3C Recommendation 14 Jan. 2003, available at www.w3.org/TR/SVGMobile/. In spite of the reduced functional scope of SVGT, demanding SVGT scenes can be generated which may overburden the resources of terminal devices. SVG is generally spoken of in the following, whereby this is understood to mean the SVG standard itself and one of the profiles of the mobile SVG standard.

One disadvantage with SVG is the fact that the terminal device may play back an SVG scene in a quality which is unacceptable to a user, the playback of individual SVG objects not being performed in real time for example. A second disadvantage is the fact that bandwidth is used when transferring the SVG document, for which a high price must be paid in the case of a mobile device although the SVG scene, deposited in the SVG document, cannot be played back perfectly on the terminal device.

### SUMMARY

An aspect therefore is to set down methods and devices which make it possible to avoid a transfer and also a playback of at least one part of an SVG scene which is unsuitable for a device.

The method relates to generating a complexity vector which represents a complexity of at least one part of an SVG scene, wherein a complexity variable associated with the respective element is determined for at least one element of a DOM tree (DOM—Document Object Model) of the SVG scene and the complexity vector is generated by the at least one of the complexity variables.

This method ensures that a complexity of an SVG scene or of a part of the SVG scene can be generated in a simple manner in the form of a complexity vector. This method is wherein the fact that it is executed once in order to generate the complexity vector and can be used again at any time if for example the desired SVG scene is retrieved by a device. In addition, the complexity of the SVG scene can be stored compactly in organized fashion with a low memory requirement through the complexity vector.

In an extension of the method, for the SVG scene which changes in time-related fashion the complexity vector is generated as a result of the fact that in each temporary instance of the DOM tree the respective complexity variable of the element is determined and a greatest value from the determined complexity variables of the element is assigned to the complexity vector.

This extension of the method takes into consideration the fact that the complexity variable of the respective elements of the SVG scene can change over time, namely dependent on temporary instances of the DOM tree. The result achieved by this extension is the fact that the complexity variables of the elements of the temporary instances are captured and compared with one another in order to then determine the greatest complexity variable for each element, which a terminal device must fulfill in order to be able to play back the present SVG graphics scene faultlessly.

In an alternative embodiment, the complexity vector is generated for the SVG scene which changes in time-related fashion as a result of the fact that
a) the respective complexity variable of the element is determined in each temporary instance of the DOM tree,
b) an associated temporary complexity number is formed for each of the temporary instances through a weighted addition of the complexity variables associated with the respective instance,
c) the complexity vector is formed through the at least one of the complexity variables of those temporary instances which has the greatest complexity number.

In this way, a weighting of the complexity variables can be performed, as a result of which a more precise ascertainment of a playback suitability of the SVG scene or of the part of the SVG scene is made possible.

In an extension of the method, at least one of the following elements and the associated complexity variables in each case are analyzed:
a) DOM storage volume of the DOM tree;
b) line segment count of line segments required for the approximation of all graphical objects;
c) area of filled graphical objects, in particular differentiated according to color, number of color gradients or fill patterns;
d) letter count of letters used in text objects, in particular differentiated according to size of the letters used;
e) data count and/or data storage volume of referenced external data, in particular differentiated according to data content and/or coding method used for the referenced external data;
f) animation count of the maximum number of animations performed simultaneously, in particular with specification of a complexity variable representing the respective animation executed;
g) script count of scripts, in particular with specification of the SVG objects referenced in the respective script.

The complexity variables of the stated elements are characterized in particular by the fact that they can be determined in a simple manner from the SVG scene. Furthermore, through combination of complexity variables of one or more of the elements it is possible to achieve a granularity of the complexity of the SVG scene.

The device is used for generating a complexity vector which represents a complexity of at least one part of an SVG scene, whereby the device has a component which is designed to determine a complexity variable of at least one element of a DOM tree of the SVG scene and to generate the complexity vector through the at least one of the complexity variables. In an alternative extension, the device can be extended to the effect that it is additionally designed to execute at least part of the method for processing temporary instances of the DOM tree and a plurality of different elements of the SVG scene. The method can be implemented and executed with the aid of this device.

The method relates to testing a playback suitability of at least one part of an SVG scene for a device, wherein the playback suitability of the SVG scene is established on the device if, upon testing, none of the complexity variables of a complexity vector of the SVG scene is greater than the associated device complexity variable of a device complexity vector of the device, whereby a maximum complexity of the element of a DOM tree of the SVG scene is played back through the complexity variable and a maximum executable complexity of the element is played back on the device through the device complexity variable.

With the aid of this method for testing, it is possible in a simple manner by using the complexity vector of the SVG scene and the device complexity vector to determine whether the device is suitable for playing back the SVG scene faultlessly.

In an alternative development of the invention, the method for testing a playback suitability of at least one part of an SVG scene for a device can be performed in accordance with the following:
a) determination of a complexity number through weighted addition of at least two complexity variables of a complexity vector, whereby a respective complexity variable represents a complexity of the associated element of a DOM tree of the SVG scene;
b) the playback suitability of the SVG scene is established on the device if the complexity number is smaller than or smaller than or equal to a device complexity number of the device, whereby a maximum complexity of the SVG scene is played back through the complexity vector and a maximum executable complexity is played back on the device through the device complexity number.

In this way it is possible to perform a weighting of the complexity variables, as a result of which a more precise determination of a playback suitability of the SVG scene or of the part of the SVG scene is made possible, particularly if the weighting takes account of specific properties of the device.

In an extension of the method for testing a playback suitability, at least one of the following elements and the associated complexity variable in each case are taken into consideration:
a) DOM storage volume of the DOM tree;
b) line segment count of line segments required for the approximation of all graphical objects;
c) area of filled graphical objects, in particular differentiated according to color, number of color gradients or fill patterns;
d) letter count of letters used in text objects, in particular differentiated according to size of the letters used;
e) data count and/or data storage volume of referenced external data, in particular differentiated according to data content and/or coding method used for the referenced external data;
f) animation count of the maximum number of animations performed simultaneously, in particular with specification of a complexity variable representing the respective animation executed;
g) script count of scripts, in particular with specification of the SVG objects referenced in the respective script.

This extension has the advantage that on the one hand the reliability of the testing of a playback suitability can be scaled by testing a greater or smaller number of elements, whereby this scaling enables the testing to take place more quickly or to last longer.

Finally the invention also includes a testing device for testing a playback suitability of an SVG scene on a device, whereby the testing device has a testing unit which is designed to execute one of the two methods for testing the playback suitability. The testing device can furthermore be extended in such a manner that the testing unit is designed to execute the testing of one or more elements and the associated complexity variables in each case. The method for testing can be implemented and executed with the aid of this testing device.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of an exemplary embodiment of a method and a device for generating a complexity vector for an SVG scene;

FIG. 2 is a block diagram of a method for testing a playback suitability of an SVG scene on a device.

### DETAILED DESCRIPTION OF THE PREFERRED EMBODIMENT

Reference will now be made in detail to the preferred embodiments, examples of which are illustrated in the accompanying drawings, elements having the same function and mode of operation are provided with the same reference characters.

The W3C (W3C—Worldwide Web Consortium, www.w3.org) has defined SVG as a language for two-dimensional graphics in XML. Graphical objects in SVG are based on simple primitives. In this situation, complex objects are composed of a plurality of simple objects. A path is the actual basic element in SVG and is specified as a quadratic or cubic Bézier curve. To this have been added the further objects circle, ellipse, rectangle, line, polyline, polygon to facilitate generation. In addition there are further graphical elements in the form of text and raster images, see SVG—Scalable Vector Graphics, 1.1 Specification and. A presentation mode for these elements can be controlled by way of attributes. Position information, width, height, radii, fill colors, stroke colors, stroke thickness, coverage of stroke and fill colors and also fill patterns can for example be specified in this situation.

SVG also enables graphical objects to be dynamically modified. This is described by specifying animation instructions which permit a time-related change in the following states: transformation, position, visibility, color and size. Alternatively, the possibility also exists through the use of script languages (for example Javascript, Pearl, PHP, JSP etc.) to manipulate a DOM structure (DOM—Document Object Model) of an SVG graphic or SVG scene and thus to permit interactions. To this end, either the script is placed for manipulation purposes in an SVG document, which describes the SVG scene, or it is referenced by way of an external file.

Audio and video objects are implemented in SVG by references to external files, the playback of which is controlled by way of associated attributes.

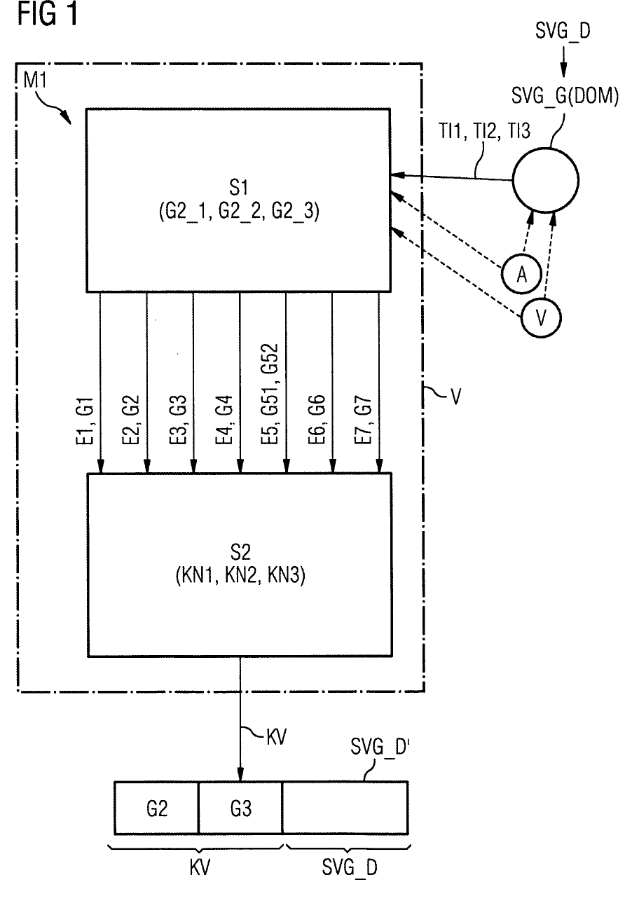

With the aid of FIG. 1, an exemplary embodiment of a method and a device for generating a complexity vector, which includes at least one complexity variable, is described in detail for at least one part of an SVG scene. In the following, mention is made of the SVG scene, whereby the SVG scene may also describe a part of an SVG scene.

FIG. 1 shows a device V for generating a complexity vector KV, whereby the complexity vector KV includes at least one complexity variable G1, G2, G3 of the SVG scene SVG_G. In a first step, identified by S1, the device reads in an SVG description in the form of a DOM tree DOM which defines the SVG scene. The SVG description is made available through an SVG document SVG_D. Moreover, in step S1 the device analyzes this DOM tree on the basis of at least one of its elements E1, E2, E3 and determines therefrom the respective associated complexity variable G1, G2, G3. The following elements are evaluated, for example:
a) A first element E1 is the DOM tree, with regard to which the associated DOM storage volume is determined as a first complexity variable G1, for example G1=162 KByte.
b) The approximation of the graphical objects in SVG is carried out on the basis of line segments, in other words paths. In this situation, a second element E2 is defined on the basis of the required line segments, whereby a number of line segments, in other words the line segment count, is played back as the associated second complexity variable G2.
c) An area of filled graphical objects serves as the third complexity variable G3, whereby the filled graphical objects represent a third element E3. For example, the SVG scene has a total of G3=5 area units of filled graphical objects E3. This third element, or the associated third complexity variable, can be further refined, for example according to color, number of color gradients or fill patterns. For example, an area G31 has two area units of filled graphical objects E31 with two colors and in addition an area G32 has three area units of filled graphical objects E32 with four colors.
d) A letter count of letters used E4 in text objects is determined as the fourth complexity variable G4, for example G4=10 letters. In this situation, the letters are the fourth element E4. Here, a refinement of the element E4 used and the associated fourth complexity variable G4 can take place. It is thus possible to further differentiate, according to a size of the letters used, how for example letters E41 used have a height of twelve points and occur with a letter count G41=eight letters, in other words eight times in the SVG scene, or letters E42 with a height of 20 points, which are represented with a letter count G42=two letters in the SVG scene.
e) The SVG scene SVG_G according to FIG. 1 references external data E5 (=fifth element E5), in the exemplary embodiment an audio file A and a video file V. This is depicted in FIG. 1 by dashed arrows. In this situation, a count of referenced external data items E5 is determined for a fifth complexity variable G51 having the name data count, in other words in the present example the data count G51=2. Moreover, it is also possible to determine a data storage volume G521 as a further fifth complexity variable G52 for the referenced external data. The data storage volume is for example G52=899 kByte for the external video and audio file. In addition, the data count G51 and/or the data storage volume G52 can be differentiated according to the data content of the external data, video or audio for example, or according to the coding method used, MP3 for the external audio data A and MPEG-2 for the external video data V for example.
f) Apart from static changes, SVG can also make dynamic changes to the objects. In this situation, a count of the maximum number of animations E6 performed simultaneously is specified as the sixth element as the sixth complexity variable G6 having the name animation count. In this situation, it is additionally possible to specify which complexity variable a particular executed animation has. For example, two objects rotating simultaneously are represented in the SVG graphics scene, meaning that the animation count G6=2. For each of the animations executed, in other words in this example the rotating objects, the area G3 or also the associated line segment count G2 can be specified.
g) As a further complexity variable, a script count G7 is specified as a seventh complexity variable G7 of scripts E7 as the seventh element E7, in particular with specification of the SVG objects referenced in the respective script.

After the complexity variables G1 to G7 of the elements E1 to E7 of the SVG scene SVG_G have been captured, these are passed from step S1 to the following step S2. In step S2, one or more complexity variables are selected from the elements determined for the SVG scene, which form the complexity vector KV. In the present exemplary embodiment according to FIG. 1, a new SVG document SVG_D′ is formed from the complexity vector KV formed and the previous SVG document SVG_D, whereby the complexity vector KV is represented for example by the complexity variables line segment count G2 and area G3. Apart from the direct specification of the respective complexity variable G1, . . . , G7, it is additionally possible to specify in the complexity vector KV for which elements E1, . . . , E7 complexity variables are specified in the complexity vector.

The SVG scene SVG_G can change over time. In this case, the entire SVG scene is not analyzed all at once but in respective temporary instances T1_1, T1_2, T1_3 of the DOM tree DOM. As an example of the second complexity variable, in other words the line segment count G2 for the line segments E2, the respective line segment count G2_1, G2_2, G2_3 is formed for each temporary instance, for example G2_1 for TI_1, G2_2 for T1_2 etc. The complexity variables of the temporary instances per element are then subsequently tested to the effect that the complexity variable associated with the tested element having a greatest value, for example the complexity variable G2_2, is selected from the previously determined complexity variables G2_1, G2_2, G2_3 for the second element, in other words the required line segments E2 of the temporary instances, as the second complexity variable G2 to be used. This selected second complexity variable is then passed to the second processing step by analogy with the above example. In analogous fashion, further elements and associated complexity variables such as for example the letters E4 used per temporary instance T1_1, T1_2, T1_3 and the associated letter count can also be determined and evaluated, with the result that the fourth complexity variable, in other words letter count G4, can be determined by the first processing step S1.

In an alternative variant embodiment to the above, the complexity variables associated with the elements are first determined for each temporary instance. The complexity variables associated with the respective temporary instance are then linked through weighted addition, for example, to a complexity number KN1, KN2, KN3 associated with the respective instance. The weighted addition can multiply all linked complexity numbers by an identical factor, 1/10 for example, or take into account the respective weighting, such that a unit of one complexity variable demands a higher complexity, in other words for example computing power, than that of a different complexity variable, with the result that the weighting is all the greater than the complexity of the respective complexity variable. After an associated complexity number has been determined for each of the temporary instances, that complexity number which has a highest value is defined. In this way, that temporary instance which has the highest complexity is defined. Finally, the complexity vector is formed through one or more of the complexity variables of the temporary instance with the defined complexity number.

The aforementioned steps S1 and S2 are executed by component M1 of a device V.

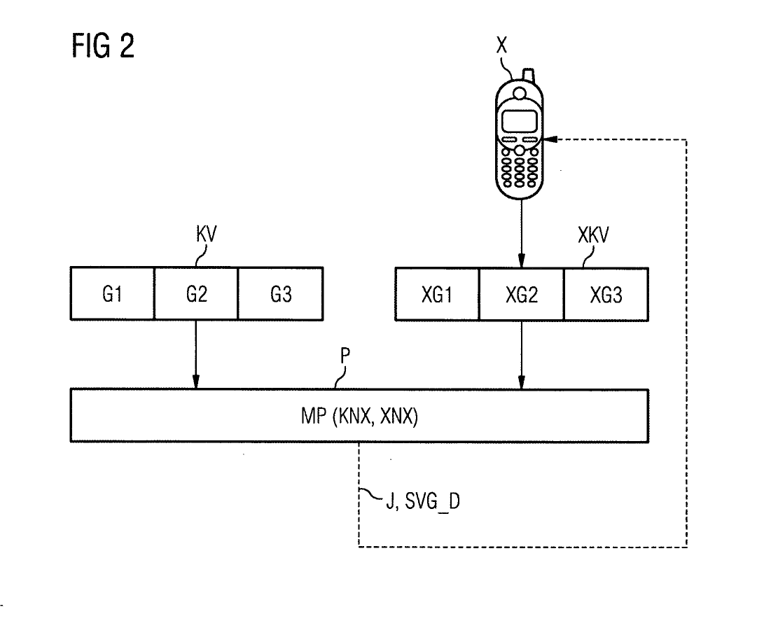

Before the modified SVG document SVG_D′ is sent to a device X, for example a terminal device X designed in the form of a mobile telephone, a multimedia server for example tests whether the device X is capable of playing back the SVG scene SVG_G. To this end, recourse is had to a device complexity vector XKV which specifies for the device X which element E1, . . . , E7 of an SVG scene can be processed with which maximum complexity. This is represented in the following example according to FIG. 2 as device complexity variable XG1, . . . , XG7 of the elements E1, . . . , E7. The following table presents the respective device complexity variables XG1 to XG7 and the corresponding complexity variable G1, . . . , G7 of the present SVG scene SVG_G for the elements E1 to E7. In this case the complexity variables G1, . . . , G7 of the complexity vector KV can be taken from the modified SVG documents SVG_D′:

| | Complexity variable | Device complexity variable |
|---|---|---|
| Element | of the SVG_G | for device X |
| E1 | G1 = 150 KByte | XG1 = 180 Kbyte |
| E2 | G2 = 5515 | XG2 = 18181 |
| E3 | G3 = 15 | XG3 = 15 |
| E4 | G4 = 128 | XG4 = 150 |
| E5 | G51 = 2 | GXG51 = 5 |
| E6 | G6 = 3 | XG6 = 3 |
| E7 | G7 = 8 | XG7 = 9 |

Since the associated device complexity variable per element is in each case greater than or equal to the associated complexity variable of the present SVG scene, this SVG scene can be played back completely and correctly by the device X. If for example XG6=2, then the present SVG graphics scene cannot be played back completely and correctly on the device X because XG6 is smaller than G6. It would be possible here for example by changing the SVG scene, such as through omitting a simultaneously executed animation, in other words a reduction to G6=2, to achieve a situation in which the device X is able to faultlessly play back the SVG scene.

In an alternative embodiment, a complexity number KNX is defined through a weighted addition of at least two of the complexity variables of the complexity vector KV. In this situation, in addition to an identical weighting of the complexity variables the weighting can also be undertaken in such a manner that a respective complexity variable, which represents an element of high complexity, receives a higher weighting factor than a complexity variable which represents a less complex element. This defined complexity number KNX is compared with a device complexity number XNX. If the defined complexity number KNX is smaller than or smaller than or equal to the device complexity number XNX, then the SVG scene can be played back on the device. The device complexity number represents a maximum complexity which can be played back on the device, for example a computing power in MIPS (MIPS—million instructions per second).

The aforementioned procedure for testing whether the device X is suitable for playing back the SVG scene is carried out using a testing device P including a testing unit MP.

The component M1 and also the testing unit MP can be implemented and executed in software, hardware or a combination of software and hardware. The method for generating and also the device for generating can for example be implemented in a video server. The complexity vector KV can also be stored separately from the SVG document SVG_D on the server for subsequent retrieval. Furthermore, the server can include the device for testing the playback suitability and also the testing device, or the testing unit. When a request is made by a mobile terminal device to transfer the SVG document, the server checks the playback suitability of the requested SVG scene. In the event that the playback suitability is established, identified by “J” in FIG. 2, the server transfers the SVG scene, in other words the SVG document SVG_D, to the terminal device X, identified by a dashed line. Otherwise, the terminal device can be notified that the SVG scene is not suitable for playback by the terminal device and is thus not transferred. Furthermore, when a request is made to transfer the SVG scene a device type of the device X can additionally be transferred, by which method the testing device can perform the weighting device-specifically and the playback suitability for the requesting device can be further enhanced.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for generating a complexity vector which represents a complexity of at least one part of a scalable vector graphics scene, comprising:
determining at least one complexity variable associated with at least one element of a document object model tree of the scalable vector graphics scene; and
generating the complexity vector based on the at least one complexity variable.

13. The method as claimed in claim 12, wherein when the scalable vector graphics scene changes in a time-related fashion, said determining is performed for each temporary instance of the document object model tree, and said generating is based on a greatest value complexity variable of the at least one element associated with the least one complexity vector.

14. The method as claimed in claim 12, wherein when the scalable vector graphics scene changes in a time-related fashion, said determining is performed for each temporary instance of the document object model tree, and said generating comprises:
forming an associated temporary complexity number for each of the temporary instances through a weighted addition of complexity variables associated with each of the temporary instances; and
basing the complexity vector on at least one of the complexity variables having a largest complexity number.

15. The method as claimed in claim 12, further comprising analyzing for the at least one element and associated complexity variable, at least one of a document object model storage volume of the document object model tree; a line segment count of line segments required for approximation of all graphical objects; areas of filled graphical objects differentiated according to color, number of color gradients or fill patterns; a letter count of letters used in text objects differentiated according to size of the letters used; a data count and/or data storage volume of referenced external data differentiated according to data content and/or coding method used for the referenced external data; an animation count of a maximum number of animations performed simultaneously with specification of a complexity variable representing respective animation executed; and a script count of scripts with specification of scalable vector graphics objects referenced in each script.

16. A method for testing playback suitability of at least one part of a scalable vector graphics scene for a device, comprising:
establishing the playback suitability of the scalable vector graphics scene on the device when for each element of a document object model tree a complexity variable of a scalable vector graphics scene complexity vector is not larger than an associated device complexity variable of a device complexity vector, where a maximum complexity of each element of the document object model tree of the scalable vector graphics scene is played back through the complexity variable and a maximum executable complexity of each element is played back on the device through the device complexity variable.

17. A method for testing playback suitability of at least one part of a scalable vector graphics scene for a device, comprising:
determining a scene complexity number through weighted addition of at least two complexity variables of a scene complexity vector, whereby a respective complexity variable represents a complexity of an associated element of a document object model tree of the scalable vector graphics scene and
establishing the playback suitability of the scalable vector graphics scene on the device when the scene complexity number is not larger than a device complexity number, whereby a maximum complexity of the scalable vector graphics scene is played back through the scene complexity vector and a maximum executable complexity is played back on the device through the device complexity number.

18. The method as claimed in claim 17, wherein said determining takes into consideration for each element and associated complexity variable, at least one of a document object model storage volume of the document object model tree; a line segment count of line segments required for approximation of all graphical objects; areas of filled graphical objects differentiated according to color, number of color gradients or fill patterns; a letter count of letters used in text objects differentiated according to size of the letters used; a data count and/or data storage volume of referenced external data differentiated according to data content and/or coding method used for the referenced external data; an animation count of a maximum number of animations performed simultaneously with specification of a complexity variable representing respective animation executed; and a script count of scripts with specification of scalable vector graphics objects referenced in each script.

19. A device for generating a complexity vector which represents a complexity of at least one part of a scalable vector graphics scene, comprising:
a processor programmed to perform operations including determining at least one complexity variable associated with at least one element of a document object model tree of the scalable vector graphics scene and generating the complexity vector based on the at least one complexity variable.

20. The device as claimed in claim 19, wherein the processor is programmed to perform the determining for each temporary instance of the document object model tree and the generating based on a greatest value complexity variable of the at least one element associated with the least one complexity vector.

21. A testing device for testing playback suitability of at least one part of a scalable vector graphics scene on a display device, comprising:
a processor programmed to perform operations including establishing the playback suitability of the scalable vector graphics scene on the display device when for each element of a document object model tree a complexity variable of a scalable vector graphics scene complexity vector is not larger than an associated device complexity variable of a device complexity vector, where a maximum complexity of each element of the document object model tree of the scalable vector graphics scene is played back through the complexity variable and a maximum executable complexity of each element is played back on the display device through the device complexity variable.

22. The testing device as claimed in claim 21, wherein the processor is programmed to perform the determining by taking into consideration for each element and associated complexity variable, at least one of a document object model storage volume of the document object model tree; a line segment count of line segments required for approximation of all graphical objects; areas of filled graphical objects differentiated according to color, number of color gradients or fill patterns; a letter count of letters used in text objects differentiated according to size of the letters used; a data count and/or data storage volume of referenced external data differentiated according to data content and/or coding method used for the referenced external data; an animation count of a maximum number of animations performed simultaneously with specification of a complexity variable representing respective animation executed; and a script count of scripts with specification of scalable vector graphics objects referenced in each script.
